(19) United States
(12) Patent Application Publication
(10) Pub. No.: US 2026/0302319 A1
(43) Pub. Date: Oct. 1, 2026

(54) ALL-SOLID-STATE BATTERY AND ALL-SOLID-STATE BATTERY MANUFACTURING METHOD

(71) Applicant: HONDA MOTOR CO., LTD., Tokyo (JP)

(72) Inventor: Yoshihiko Nakajima, Wako-shi (JP)

(21) Appl. No.: 19/551,648

(22) Filed: Feb. 27, 2026

(30) Foreign Application Priority Data
Mar. 25, 2025 (JP) 2025-049774

(51) Int. Cl. H01M 10/04; H01M 50/105

(52) U.S. Cl. CPC H01M 10/0481; H01M 50/105

(57) ABSTRACT

An all-solid-state battery includes: an electrode laminate body in which a plurality of electrode bodies are laminated; an exterior film that accommodates the electrode laminate body; and a press member that is adjacent to a corner portion of the electrode laminate body and extends in a lamination direction of the electrode laminate body, wherein the press member presses the exterior film outward in the lamination direction of the electrode laminate body, and an extra length portion of the exterior film is provided along an edge portion of an outermost surface in the lamination direction of the electrode laminate body.

### CROSS-REFERENCE TO RELATED APPLICATION

Priority is claimed on Japanese Patent Application No. 2025-049774, filed on Mar. 25, 2025, the contents of which are incorporated herein by reference.

### BACKGROUND

### Field of the Invention

The present invention relates to an all-solid-state battery and an all-solid-state battery manufacturing method.

### Background

In recent years, in order to ensure that more people have access to affordable, reliable, sustainable, and advanced energy, research and development relating to an all-solid-state battery, which contributes to energy efficiency, has been conducted.

In an all-solid-state battery, when a negative electrode is formed of an expandable material such as a lithium metal or silicon, the volume varies at the time of charging and discharging, and therefore, a pouch-type laminate that absorbs the displacement of expansion and contraction of a battery cell is required. At present, a structure exists which absorbs the displacement described above by using a setting having an extra length by wrapping an electrode laminate body with a laminate film having a cup height formed to be deeper than the thickness of the electrode laminate body at EOL (End of Life) SOC (State of Charge) 100% (for example, refer to Japanese Unexamined Patent Application, First Publication No. 2011-71133).

### SUMMARY

It is confirmed that, when an exterior film presses an end portion of the electrode laminate body after vacuum sealing, the bending of the electrode laminate body increases when the battery cell expands due to the expansion of a negative electrode, and a stress generated at a solid electrolyte increases. As a result, the robustness of a structure design may be reduced.

An aspect of the present invention aims at providing an all-solid-state battery and an all-solid-state battery manufacturing method that prevent a laminate film from pressing the outermost surface of an electrode laminate body and prevent bending of the electrode laminate body from increasing at the time of expansion of a battery cell. The aspect of the present invention contributes to stable battery performance, improvement in quality control over manufacturing steps, and energy efficiency.

A first aspect of the present invention is an all-solid-state battery including: an electrode laminate body in which a plurality of electrode bodies are laminated; an exterior film that accommodates the electrode laminate body; and a press member that is adjacent to a corner portion of the electrode laminate body and extends in a lamination direction of the electrode laminate body, wherein the press member presses the exterior film outward in the lamination direction of the electrode laminate body, and an extra length portion of the exterior film is provided along an edge portion of an outermost surface in the lamination direction of the electrode laminate body.

According to the first aspect described above, since the press member that extends in the lamination direction of the electrode laminate body is provided adjacent to the corner portion of the electrode laminate body, and the press member presses the exterior film outward in the lamination direction of the electrode laminate body, the extra length portion of the exterior film is provided along the edge portion of the outermost surface in the lamination direction of the electrode laminate body, and therefore, even if the exterior film presses the outermost surface of the electrode laminate body when the electrode laminate body is covered by the exterior film, it is possible to prevent bending of the electrode laminate body from increasing at the time of expansion of the electrode laminate body and prevent the edge portion of the outermost surface in the lamination direction of the electrode laminate body from being broken.

A second aspect is the all-solid-state battery according to the first aspect described above, wherein a shape in a cross section in the lamination direction of the electrode laminate body in the extra length portion may be an arc shape that curves at a position further away from the edge portion.

According to the second aspect described above, since the shape in the cross section in the lamination direction of the electrode laminate body in the extra length portion is an arc shape that curves at a position further away from the edge portion of the outermost surface in the lamination direction of the electrode laminate body, it is possible to prevent the extra length portion from being damaged when an external force is applied to the extra length portion of the exterior film. Further, the extra length portion is formed when the electrode laminate body is sealed by the exterior film that has the same depth as the thickness of the electrode laminate body after expansion in the lamination direction of the electrode laminate body and has the minimum clearance required for assembly of the electrode laminate body in a substantially perpendicular direction to the lamination direction of the electrode laminate body. The extra length portion is formed such that, in the substantially perpendicular direction to the lamination direction of the electrode laminate body, a connection end between the exterior film and the electrode laminate body is away from an end of the electrode laminate body as much as possible.

A third aspect is the all-solid-state battery according to the first or second aspect described above, wherein a buffer material may be arranged on the outermost surface in the lamination direction of the electrode laminate body in a region inside the extra length portion in an outermost surface of the exterior film.

According to the third aspect described above, by arranging the buffer material at a predetermined position with reference to the press member, it is possible to prevent the electrode laminate body from being damaged when an external force is applied. Further, since the number of components and tools that constitute variation in the assembly position of the electrode laminate body is reduced, it is possible to reduce the accuracy required for the components and tools, which leads to cost reduction.

A fourth aspect is a an all-solid-state battery manufacturing method including: arranging corner portions of a plurality of electrode bodies to be adjacent to a press member, positioning the corner portions, laminating the plurality of electrode bodies, and forming an electrode laminate body; and covering the electrode laminate body and the press member by an exterior film.

According to the fourth aspect described above, since the exterior film can be pressed outward in a lamination direction of the electrode laminate body by the press member at the corner portion of the electrode laminate body, it is possible to provide an extra length portion of the exterior film, and even if the exterior film presses the outermost surface of the electrode laminate body when the electrode laminate body is covered by the exterior film, it is possible to prevent bending of the electrode laminate body from increasing at the time of expansion of the electrode laminate body.

According to the aspect of the present invention, it is possible to provide an all-solid-state battery and an all-solid-state battery manufacturing method that prevent a laminate film from pressing the outermost surface of an electrode laminate body and prevent bending of the electrode laminate body from increasing at the time of expansion of a battery cell.

### BRIEF DESCRIPTION OF THE DRAWINGS

FIG. 1 is a cross-sectional view showing an all-solid-state battery according to an embodiment of the present invention.

FIG. 2 is a cross-sectional view showing the all-solid-state battery according to the embodiment of the present invention.

### DESCRIPTION OF EMBODIMENTS

Hereinafter, an embodiment of the present invention will be described in detail with reference to the drawings.

### All-Solid-State Battery

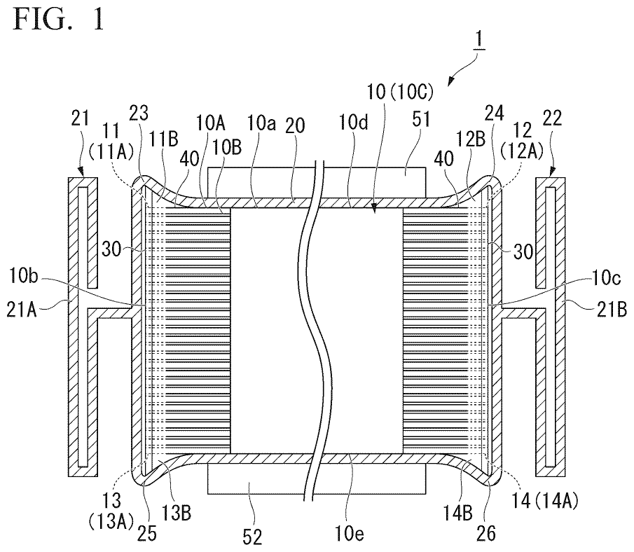

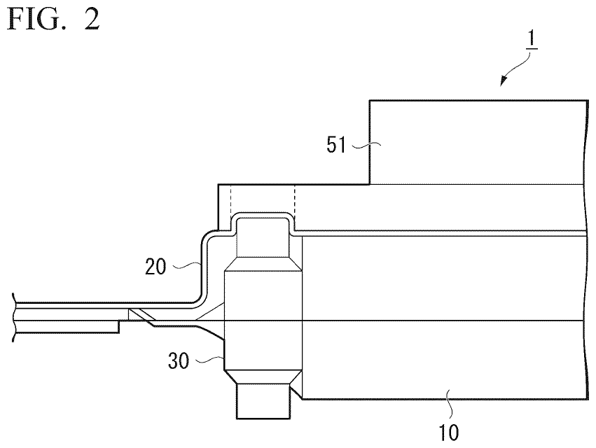

FIG. 1 is a cross-sectional view showing an all-solid-state battery according to an embodiment of the present invention. FIG. 2 is a cross-sectional view showing the all-solid-state battery according to the embodiment of the present invention. In the drawings used in the following description, in order to make characteristics easy to understand, characteristic portions may be shown in an enlarged manner for the sake of convenience, and dimensional ratios or the like of each constituent element are not limited to exemplary examples.

As shown in FIG. 1 and FIG. 2, an all-solid-state battery 1 of the present embodiment includes an electrode laminate body 10, an exterior film 20, and a press member 30. The exterior film 20 covers an outer surface 10a of the electrode laminate body 10 and accommodates the electrode laminate body 10.

The electrode laminate body 10 has a positive electrode 10A, a negative electrode 10B, and a solid electrolyte layer (not shown). In other words, the electrode laminate body 10 is formed by alternately laminating a plurality of positive electrodes (electrode bodies) 10A and a plurality of negative electrodes (electrode bodies) 10B via a solid electrolyte.

The exterior film 20 has an accommodation portion 10C that accommodates the electrode laminate body 10 and two sealing portions 21, 22 that are formed on a circumferential edge of the accommodation portion 10C and are arranged in a direction orthogonal to a lamination direction of the electrode laminate body 10. That is, the sealing portions 21, 22 are arranged so as to face side surfaces 10b, 10c in the lamination direction of the electrode laminate body 10, respectively. The sealing portion 21, 22 includes fold portions 21A, 22A formed by folding the exterior film 20 double. The fold portions 21A, 22A can preferably have a portion that extends in the lamination direction of the electrode laminate body 10. Thereby, it is possible to prevent a force of peeling by expansion and contraction of the electrode laminate body 10 from being applied to the sealing portions 21, 22. The lamination direction of the electrode laminate body 10 means the thickness direction of the electrode laminate body 10 after expansion.

The press member 30 that extends in the lamination direction of the electrode laminate body 10 is arranged adjacent to the corner portions 11, 12, 13, 14 of the electrode laminate body 10. The press member 30 presses the exterior film 20 outward in the lamination direction of the electrode laminate body 10. Thereby, extra length portions 23, 24, 25, 26 of the exterior film 20 are provided along edge portions 11A, 12A, 13A, 14A at outermost surfaces (an upper surface 10d in the lamination direction of the electrode laminate body 10 and a lower surface 10e in the lamination direction of the electrode laminate body 10) in the lamination direction of the electrode laminate body 10. By providing the extra length portions 23, 24, 25, 26 of the exterior film 20, gaps 11B, 12B, 13B, 14B are provided between the exterior film 20 and the edge portions 11A, 12A, 13A, 14A at the outermost surfaces in the lamination direction of the electrode laminate body 10.

Thereby, even if the exterior film 20 presses the outer surface (outermost surface) 10a of the electrode laminate body 10 when the electrode laminate body 10 is covered by the exterior film 20, it is possible to prevent bending of the electrode laminate body 10 from increasing at the time of expansion of the electrode laminate body 10 and prevent the edge portions 11A, 12A, 13A, 14A of the outermost surfaces in the lamination direction of the electrode laminate body 10 from being broken.

The extra length portions 23, 24, 25, 26 of the exterior film 20 mean a portion of the exterior film 20 that is not in contact with the electrode laminate body 10 but is separated from the electrode laminate body 10. The shape in the cross section in the lamination direction of the electrode laminate body 10 in the extra length portions 23, 24, 25, 26 is an arc shape that curves at a position further away from the edge portions 11A, 12A, 13A, 14A. Thereby, it is possible to prevent the extra length portions 23, 24, 25, 26 from being damaged when an external force is applied to the extra length portions 23, 24, 25, 26 of the exterior film 20.

The length of the extra length portions 23, 24, 25, 26, that is, the length of the exterior film 20 which is separated from the electrode laminate body 10 can be preferably equal to or more than 1 mm and equal to or less than 3 mm and can be more preferably equal to or more than 1 mm and equal to or less than 1.5 mm. When the length of the extra length portions 23, 24, 25, 26 is within the above range, it is possible to prevent the entire exterior film 20 from extending due to expansion and contraction of the electrode laminate body 10 and prevent a force of peeling from being applied to the sealing portions 21, 22. Further, the length of the exterior film 20 separated from the electrode laminate body 10 is the maximum length of the gaps 11B, 12B, 13B, 14B in the lamination direction of the electrode laminate body 10.

The all-solid-state battery 1 can preferably include an insulation layer 40 that covers the side surfaces 10b, 10c in the lamination direction of the electrode laminate body 10. Further, the gaps 11B, 12B, 13B, 14B can be preferably arranged in the vicinity of the insulation layer 40. In other words, the extra length portions 23, 24, 25, 26 of the exterior film 20 can be preferably arranged in the vicinity of the insulation layer 40. By providing the insulation layer 40, it is possible to prevent the electrode laminate body 10 and the exterior film 20 from coming into contact with each other and prevent the electrode laminate body 10 and the exterior film 20 from short-circuiting. Further, by arranging the gaps 11B, 12B, 13B, 14B in the vicinity of the insulation layer 40, even if the exterior film 20 and the insulation layer 40 come into contact with each other by the expansion and contraction of the electrode laminate body 10, it is possible to prevent the electrode laminate body 10 and the exterior film 20 from short-circuiting.

A starting end of the extra length portions 23, 24, 25, 26 can be preferably located, in a direction orthogonal to the lamination direction of the electrode laminate body 10, at an end portion on the side of a positive electrode active material layer that constitutes the electrode laminate body 10 in the insulation layer 40. The starting end of the extra length portions 23, 24, 25, 26 can be more preferably located, in the direction orthogonal to the lamination direction of the electrode laminate body 10, at a position from an end on the side of the positive electrode active material layer that constitutes the electrode laminate body 10 in the insulation layer 40 by a distance equal to or more than ⅓ and equal to or less than ½ of the length of the insulation layer 40.

Buffer materials 51, 52 can be preferably arranged on the outermost surfaces (the upper surface 10d in the lamination direction of the electrode laminate body 10 and the lower surface 10e in the lamination direction of the electrode laminate body 10) in the lamination direction of the electrode laminate body 10 in a region inside the extra length portions 23, 24, 25, 26 in an outermost surface 20a of the exterior film 20. The buffer materials 51, 52 are arranged at a predetermined position with reference to the press member 30.

Since the electrode laminate body 10 is accommodated in the exterior film 20, it is difficult to arrange the buffer materials 51, 52 at an appropriate position from the outermost surface side of the exterior film 20. Therefore, by arranging the buffer materials 51, 52 with reference to the press member 30, it is possible to arrange the buffer materials 51, 52 at an appropriate position. By arranging the buffer materials 51, 52, it is possible to prevent the electrode laminate body 10 from being damaged when an external force is applied.

The buffer materials 51, 52 can be preferably arranged, in the direction orthogonal to the lamination direction of the electrode laminate body 10, in a region within ⅓ of the length of the insulation layer 40 from the end on the side of the positive electrode active material layer that constitutes the electrode laminate body 10 in the insulation layer 40.

### Positive Electrode

The positive electrode is constituted by laminating a first current collector layer and a first active material layer including at least a positive electrode active material. In the present embodiment, the positive electrode has the first current collector layer and first active material layers formed on both main surfaces of the first current collector layer.

The first current collector layer can be preferably constituted of at least one material having a high conductivity.

Examples of the material having a high conductivity include a metal or an alloy containing at least one of metal elements such as silver (Ag), palladium (Pd), gold (Au), platinum (Pt), aluminum (Al), chromium (Cr), and nickel (Ni), or a non-metal such as carbon (C). In consideration of manufacturing costs in addition to the high conductivity, aluminum, nickel, or stainless steel can be preferably used. Further, aluminum is unlikely to react with the positive electrode active material and an electrolyte. Therefore, when aluminum is used for the first current collector layer, the internal resistance of the battery can be reduced.

Examples of forms of the first current collector layer can include a foil form, a plate form, a mesh form, a non-woven fabric form, a foam form, and the like. Further, in order to enhance adhesion to the first active material layer, carbon or the like may be arranged on a surface of the first current collector layer, or the surface may be coarsened.

The first active material layer contains a positive electrode active material that exchanges lithium ions and electrons. The positive electrode active material is not particularly limited as long as the positive electrode active material is a material capable of reversibly releasing and absorbing lithium ions and transferring electrons, and a known positive electrode active material that is applicable to a positive electrode of a lithium-ion battery can be used. Examples of the positive electrode active material include: composite oxides such as lithium cobalt oxide (LiCoO₂), lithium nickel oxide (LiNiO₂), lithium manganese oxide (LiMn₂O₄), solid solution oxides (Li₂MnO₃—LiMO₂ (M═Co, Ni, or the like)), lithium-manganese-nickel-cobalt oxide (LiNiₓMn_{y}Co_{z}O₂, x+y+z=1), and olivine-type lithium phosphate oxide (LiFePO₄); conductive polymers such as polyaniline and polypyrrole; sulfides such as Li₂S, CuS, Li—Cu—S compounds, TiS₂, FeS, MoS₂, and Li—Mo—S compounds; mixtures of sulfur and carbon; and the like. The positive electrode active material may be constituted of one of the above materials alone or may be constituted of two or more thereof.

The first active material layer contains an electrolyte that exchanges lithium ions with the positive electrode active material. The electrolyte is not particularly limited as long as the electrolyte has lithium-ion conductivity, and a material generally used for a lithium-ion battery can be used. Examples of the electrolyte can include: inorganic solid electrolytes such as sulfide solid electrolyte materials, oxide solid electrolyte materials, halide solid electrolytes, and lithium-containing salts; polymer-based solid electrolytes such as polyethylene oxide; gel-based solid electrolytes containing lithium-containing salts or lithium-ion conductive ionic liquids; and the like.

Among these, sulfide solid electrolyte materials can be preferably used from the viewpoint of high conductivity properties of lithium ions, favorable structural formability by pressing, and favorable interfacial bonding properties.

The electrolyte may be constituted of one of the above materials alone or may be constituted of two or more thereof.

The electrolyte contained in the first active material layer may be the same material as or may be a material different from the electrolyte contained in a second active material layer and the solid electrolyte layer.

The first active material layer may contain a conductive additive from the viewpoint of improvement in conductivity of the positive electrode. As the conductive additive, a conductive additive which is capable of being generally used for a lithium-ion battery can be used.

Examples of the conductive additive can include: carbon black such as acetylene black or Ketjen black; carbon fibers; vapor grown carbon fibers; graphite powder; and carbon materials such as carbon nanotubes. The conductive additive may be constituted of one of the above materials alone or may be constituted of two or more thereof.

Further, the first active material layer may contain a binder that plays a role in binding the positive electrode active materials to each other, and the positive electrode active material and the first current collector layer to each other.

In the present embodiment, the first active material layer is formed on both main surfaces of the first current collector layer; however, the present embodiment is not limited to this. The first active material layer may be formed only on one main surface of the first current collector layer. Further, in the case where the positive electrode is a single-sided coated electrode, a laminate positive electrode in which current collector surfaces of two positive electrodes are laminated so as to face each other may be used as a double-sided coated electrode. Further, in the case where the first current collector layer has a three-dimensional porous structure such as a mesh form, a non-woven fabric form, or a foam form, the first current collector layer may be provided integrally with the first active material layer.

The first current collector layer is bundled at one end portion in a width direction of the all-solid-state battery.

The first active material layer is in contact with the solid electrolyte layer and may therefore contain sulfides contained in the solid electrolyte layer.

### Negative Electrode

The negative electrode is constituted by laminating a second current collector layer and a second active material layer containing a negative electrode active material. In the present embodiment, the negative electrode has a second current collector layer and a second active material layer that is formed on both main surfaces of the second current collector layer and contains a negative electrode active material and an electrolyte.

The second current collector layer contains copper (Cu). Similarly to the first current collector layer, the second current collector layer may contain a material other than copper having a high conductivity. Examples of the material other than copper having a high conductivity include a metal or an alloy containing at least one of metal elements such as silver (Ag), palladium (Pd), gold (Au), platinum (Pt), chromium (Cr), and nickel (Ni), or a non-metal such as carbon (C). In consideration of manufacturing costs in addition to the high conductivity, nickel or stainless steel can be preferably used as the material other than copper. Further, stainless steel is unlikely to react with the positive electrode active material, the negative electrode active material, and the electrolyte. Therefore, when stainless steel is used for the second current collector layer, the manufacturing costs of the battery can be reduced.

Examples of forms of the second current collector layer can include a foil form, a plate form, a mesh form, a non-woven fabric form, a foam form, and the like. Further, in order to enhance adhesion to the second active material layer, carbon or the like may be arranged on a surface of the second current collector layer, or the surface may be coarsened.

The second active material layer contains the negative electrode active material that exchanges lithium ions and electrons. The negative electrode active material is not particularly limited as long as the negative electrode active material is a material capable of reversibly releasing and absorbing lithium ions and transferring electrons, and a known negative electrode active material that is applicable to a negative electrode of a lithium-ion battery can be used. Examples of the negative electrode active material include: carbonaceous materials such as natural graphite, artificial graphite, resin charcoal, carbon fibers, activated charcoal, hard carbon, and soft carbon; alloy-based materials mainly consisting of tin, a tin alloy, silicon, a silicon alloy, gallium, a gallium alloy, indium, an indium alloy, aluminum, an aluminum alloy, and the like; conductive polymers such as polyacene, polyacetylene, and polypyrrole; metallic lithium; and lithium alloys such as lithium-titanium composite oxides (for example, Li₄Ti₅O₁₂) Sn—Li alloys, Ag—Li alloys, Mg—Li alloys, In—Li alloys, Si—Li alloys, and Al—Li alloys. These negative electrode active materials may be constituted of one of the above materials alone or may be constituted of two or more thereof.

The second active material layer contains a negative electrode active material. The second active material layer may contain an electrolyte that performs exchange of lithium ions. The electrolyte is not particularly limited as long as the electrolyte has lithium-ion conductivity, and a material generally used for a lithium-ion battery can be used.

Examples of the electrolyte can include: inorganic solid electrolytes such as sulfide solid electrolyte materials, oxide solid electrolyte materials, halide solid electrolytes, and lithium-containing salts; polymer-based solid electrolytes such as polyethylene oxide; gel-based solid electrolytes containing lithium-containing salts or lithium-ion conductive ionic liquids; and the like. The electrolyte may be constituted of one of the above materials alone or may be constituted of two or more thereof.

The electrolyte contained in the second active material layer may be similar to or different from the electrolyte contained in the first active material layer and the solid electrolyte layer.

The second active material layer may contain a conductive additive, a binder, and the like. These materials are not particularly limited, but, for example, materials similar to those used for the first active material layer described above can be used.

In the present embodiment, the second active material layer is formed on both main surfaces of the second current collector layer; however, the present embodiment is not limited to this. The second active material layer may be formed only on one main surface of the second current collector layer. Further, in the case where the second current collector layer has a three-dimensional porous structure such as a mesh, a non-woven fabric, or a foam, the second current collector layer may be provided integrally with the second active material layer.

The negative electrode may be a lithium metal or silicon.

### Solid Electrolyte Layer

The solid electrolyte layer is arranged between the first active material layer and the second active material layer.

The electrolyte is not particularly limited as long as the electrolyte has lithium-ion conductivity and insulation properties, and a material generally used for a lithium-ion battery can be used. Examples of the electrolyte can include: inorganic solid electrolytes such as sulfide solid electrolyte materials, oxide solid electrolyte materials, halide solid electrolytes, and lithium-containing salts; polymer-based solid electrolytes such as polyethylene oxide; gel-based electrolytes containing lithium-containing salts or lithium-ion conductive ionic liquids; and the like. Among these, sulfide solid electrolyte materials can be preferably used from the viewpoint of high conductivity properties of lithium ions, favorable structural formability by pressing, and favorable interfacial bonding properties.

The form of the electrolyte materials is not particularly limited, but examples of the form can include particles.

The solid electrolyte layer may contain an adhesive for imparting mechanical strength and flexibility.

The solid electrolyte layer may have a sheet shape having a porous substrate and a solid electrolyte held in the porous substrate. The form of the porous substrate described above is not particularly limited, but examples of the form include woven fabric, non-woven fabric, mesh cloth, a porous film, an expanded sheet, a punching sheet, and the like. Among these forms, non-woven fabric can be preferably used from the viewpoint of handleability in which the filling amount of a solid electrolyte can be enhanced.

The porous substrate described above can be preferably constituted of an insulation material. Thereby, insulation properties of the solid electrolyte layer can be improved. Examples of the insulation material include: resin materials such as nylon, polyester, polyethylene, polypropylene, polytetrafluoroethylene, an ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, and an acrylic resin; natural fibers such as hemp, wood pulp, and cotton lint; glass; and the like.

### Exterior Film

The exterior film 20 is a laminate film having an inner resin layer, a metal layer, and an outer resin layer. Examples of the resin that constitutes the inner resin layer and the outer resin layer include polyester resins such as polyethylene terephthalate (PET). The metal layer is constituted of, for example, an aluminum foil or the like.

### Press Member

The material that constitutes the press member 30 is not particularly limited, but examples thereof include insulation materials such as high-purity alumina and resin.

The shape of the press member 30 is not particularly limited, but examples thereof include a cylindrical shape.

### Insulation Layer

The insulation material that constitutes the insulation layer 40 is not particularly limited, but examples thereof include high-purity alumina.

### Buffer Material

The buffer materials 51, 52 are not particularly limited, but examples thereof include one made of a material having a thermal conductivity and elasticity, and the like.

According to the all-solid-state battery 1 of the present embodiment, since the press member 30 that extends in the lamination direction of the electrode laminate body 10 is provided adjacent to the corner portions 11, 12, 13, 14 of the electrode laminate body 10, and the press member 30 presses the exterior film 20 outward in the lamination direction of the electrode laminate body 10, the extra length portions 23, 24, 25, 26 of the exterior film 20 are provided, and even if the exterior film 20 presses the outermost surface of the electrode laminate body 10 when the electrode laminate body 10 is covered by the exterior film 20, it is possible to prevent bending of the electrode laminate body 10 from increasing at the time of expansion of the electrode laminate body 10. Since the shape in the cross section in the lamination direction of the electrode laminate body 10 in the extra length portions 23, 24, 25, 26 is an arc shape that curves at a position further away from the edge portion of the outermost surface (outer surface) 10a in the lamination direction of the electrode laminate body 10, it is possible to prevent the extra length portion 23, 24, 25, 26 from being damaged when an external force is applied to the extra length portion 23, 24, 25, 26 of the exterior film 20. Further, the extra length portions 23, 24, 25, 26 are formed when the clearance between the electrode laminate body 10 and the exterior film 20 in a substantially perpendicular direction to the lamination direction of the electrode laminate body 10 is decreased when the electrode laminate body 10 is sealed by the exterior film 20 that has a depth similar to the thickness of the electrode laminate body 10 after expansion in the lamination direction of the electrode laminate body 10. The extra length portions 23, 24, 25, 26 are formed such that, in the substantially perpendicular direction to the lamination direction of the electrode laminate body 10, a connection end between the exterior film 20 and the electrode laminate body 10 is away from an end of the electrode laminate body 10 as much as possible.

### All-Solid-State Battery Manufacturing Method

An all-solid-state battery manufacturing method according to an embodiment of the present invention includes: a step (hereinafter, referred to as a “first step”) of arranging corner portions of a plurality of electrode bodies to be adjacent to a press member, positioning the corner portions, laminating the plurality of electrode bodies, and forming an electrode laminate body; and a step (hereinafter, referred to as a “second step”) of covering the electrode laminate body and the press member by an exterior film.

With reference to FIG. 1, the all-solid-state battery manufacturing method of the present embodiment is described.

### First Step

In the first step, corner portions of a plurality of electrode bodies (the positive electrode 10A and the negative electrode 10B) are arranged adjacent to the press member 30 and are positioned, the plurality of electrode bodies are laminated, and the electrode laminate body 10 is formed.

When positioning the corner portions of the plurality of electrode bodies, for example, the laminated electrode bodies are sandwiched by a frame member from both sides in the lamination direction, and the press member 30 is inserted through a penetration hole that is formed in the corner portion of the frame member and penetrates in the thickness direction of the frame member. The corner portion of the frame member is arranged in the vicinity of the corner portion of the electrode body. Thereby, the corner portions of the plurality of electrode bodies are arranged adjacent to the press member 30.

### Second Step

In the second step, the electrode laminate body 10 and the press member 30 arranged adjacent to the corner portion of the electrode laminate body 10 are covered by the exterior film 20. Then, vacuuming of the inside (a space that accommodates the electrode laminate body 10) of the exterior film 20 is performed, and the exterior film 20 is caused to come into close contact with the electrode laminate body 10 and the press member 30. Thereby, the press member 30 is in a state of pressing the exterior film 20 outward in the lamination direction of the electrode laminate body 10, and therefore, the extra length portions 23, 24, 25, 26 of the exterior film 20 are formed along the edge portions 11A, 12A, 13A, 14A of the outermost surface in the lamination direction of the electrode laminate body 10.

According to the all-solid-state battery manufacturing method of the present embodiment, since the exterior film 20 can be pressed outward in the lamination direction of the electrode laminate body 10 by the press member 30 at the corner portions 11, 12, 13, 14 of the electrode laminate body 10, it is possible to provide the extra length portions 23, 24, 25, 26 of the exterior film 20, and even if the exterior film 20 presses the outermost surface of the electrode laminate body 10 when the electrode laminate body 10 is covered by the exterior film 20, it is possible to prevent bending of the electrode laminate body 10 from increasing at the time of expansion of the electrode laminate body 10.

Although the embodiment of the present invention has been described in detail, the present invention is not limited to the embodiment described above, and various modifications and changes can be made within the scope of the gist of the present invention described in the claims.

What is claimed is:

1. An all-solid-state battery comprising:
an electrode laminate body in which a plurality of electrode bodies are laminated;
an exterior film that accommodates the electrode laminate body; and
a press member that is adjacent to a corner portion of the electrode laminate body and extends in a lamination direction of the electrode laminate body,
wherein the press member presses the exterior film outward in the lamination direction of the electrode laminate body, and
an extra length portion of the exterior film is provided along an edge portion of an outermost surface in the lamination direction of the electrode laminate body.

2. The all-solid-state battery according to claim 1,
wherein a shape in a cross section in the lamination direction of the electrode laminate body in the extra length portion is an arc shape that curves at a position further away from the edge portion.

3. The all-solid-state battery according to claim 1,
wherein a buffer material is arranged on the outermost surface in the lamination direction of the electrode laminate body in a region inside the extra length portion in an outermost surface of the exterior film.

4. An all-solid-state battery manufacturing method comprising:
arranging corner portions of a plurality of electrode bodies to be adjacent to a press member, positioning the corner portions, laminating the plurality of electrode bodies, and forming an electrode laminate body; and
covering the electrode laminate body and the press member by an exterior film.
